(19) United States
(12) Patent Application Publication
(10) Pub. No.: US 2007/0000912 A1
(43) Pub. Date: Jan. 4, 2007

(54) Micron conductive fiber heater elements

(76) Inventor: Thomas Aisenbrey, Littleton, CO (US)

Correspondence Address: DOUGLAS R. SCHNABEL, 1531 WEDGEWOOD PLACE, ESSEXVILLE, MI, 48732, US

(21) Appl. No.: 11/477,882

(22) Filed: Jun. 29, 2006

Related U.S. Application Data
(60) Provisional application No. 60/695,037, filed on Jun. 29, 2005.

(51) Int. Cl. H05B 3/34

(52) U.S. Cl. 219/528

(57) ABSTRACT

A heating element device comprises a bundle of micron conductive fiber. Each micron conductive fiber has a diameter of typically not greater than 20 microns. The bundle is operative to conduct electrical current from a first end to a second end of the bundle. An electrical insulating material may surround the bundle. The bundle may be held near, or contacting, a thermal spreading structure. The fiber may be metal or metal plated onto metal core or non-metal core. The fiber may be ferromagnetic. Superconductor metals may also be used as micron conductive fibers and/or as metal plating onto fibers in the present invention.

### RELATED PATENT APPLICATIONS

This Patent Application claims priority to the U.S. Provisional Patent Application 60/695,037, filed on Jun. 29, 2005, which is herein incorporated by reference in its entirety.

### BACKGROUND OF THE INVENTION

(1) Field of the Invention

This invention relates to micron conductive fiber heater elements including methods of manufacture and applications.

(2) Description of the Prior Art

From common kitchen appliances to sophisticated temperature control devices for scientific application, resistive heating elements are ubiquitous in application. Most heating elements are highly resistive metal wire, such as nickel-chromium (nichrome) or tungsten, designed to provide the necessary resistance for the heating required. The resistance of the heating element is determined by the resistivity of the wire, its cross-sectional area, and its length. The heat generated by the heating element is determined by the current passing through the heating element. Typically, the heating element further comprises an outer layer of a material that serves as an electrical insulator and a thermal conductor.

Heat generated in a resistive heating element is transferred to heated objects by conduction, convection and/or radiation. Conduction heat transfer relies on direct contact between the heating element and the heated object. For example, the transfer of heat from an electric range to a metal pan is essentially by conduction. Convection heat transfer relies on fluid flow to transfer heat. For example, an egg cooking a pan of boiling water relies on convection currents to transfer heat from the metal pan through the water and to the egg. Water at the bottom of the pan is superheated causing it to lose density such that it rises. This rising superheated water transfers heat energy to the egg floating in the water. Conversely, the water at the top of the pan is cooler and denser and, therefore, falls to toward the bottom of the pan. Convection current is thereby established in the pan of water. Radiation heat transfer relies on electromagnetic energy (such as light) to transfer heat from the heating element to the object. For example, a cake baking in an electric oven will be heated, in part, by the radiated heat from the glowing heating element. Radiant heating in how the sun's energy reaches the earth. In practical application, the three means of thermal transfer are found to interact and frequently occur at the same time.

Resistive heating elements used in various heating systems and applications have advantages over, for example, combustion-based heating sources. Electric heating elements do not generate noxious or asphyxiating fumes. Electric heating elements may be precisely controlled by electrical signals and, further, by digital circuits. Electrical heating elements can be formed into many shapes. Very focused heating can be created with minimal heat exposure for nearby objects. Heating can be performed in the absence of oxygen. Fluids, even combustible fluids, can be heated by properly designed resistive heating elements.

However, resistive heating elements currently used in the art have disadvantages. Metal-based elements, and particularly nichrome and tungsten, can be brittle and therefore not suitable for applications requiring a flexible heating element. Further, the large thermal cycles inherent in many product applications and the brittleness of these materials will cause thermal fatigue. Other metal elements, such as copper-based elements, bring greater flexibility. However, if the application requires the resistive element to change or flex positions, then the resistive element will tend to wear out due to metal fatigue. Metal-based resistive heating elements are typically formed as metal wires. These elements are expensive, can require very high temperature processing, and are limited in shape. In addition, when a breakage occurs, typically due to fatigue as described above, then the entire element stops working and must be replaced.

Several prior art inventions relate to resin-coated, micron conductive fiber wiring. U.S. Patent Publication US 2002/0127006 A1 to Tweedy et al teaches a small diameter low watt density immersion heating element that utilizes a wire, braid, mesh, ribbon, or foil as the resistive heat element. This patent also teaches the element could be made from a nichrome, copper alloy, steel alloy, or stainless steel alloy. The insulator could b made from glass, ceramic, polymer, or coated aluminum. U.S. Patent Publication US 2003/0121140 A1 to Arx et al teaches a heat element assembly that utilizes a resistance heating element positioned between two thermoplastic layers. The heating element may be a resistive wire. The wire is sewn into a substrate. The wire is between 5 mil and 0.25 inches in diameter. U.S. Patent Publication US 2002/0146244 A1 to Thweatt, Jr., teaches an electrical heater for fluids that utilizes a heating element comprising an outer sheath made of a titanium material and an inner sheath made of a stainless steel material. U.S. Patent Publication US 2004/0169028 A1 to Hadzizukic et al teaches a heated handle and a method of manufacture and more specifically teaches a heated steering wheel for an automobile. The invention utilizes 5 to 7 wire strands consisting of copper woven together having a diameter between 0.008 mm and about 0.009 mm as the resistive heat element.

### SUMMARY OF THE INVENTION

A principal object of the present invention is to provide a low cost and highly effective heating element.

This objective is achieved by fabricating a micron conductive fiber heating element.

A heating element device is achieved comprising a bundle of micron conductive fiber. Each micron conductive fiber has a diameter of typically not greater than 20 microns. The bundle is operative to conduct electrical current from a first end to a second end of the bundle.

### BRIEF DESCRIPTION OF THE DRAWINGS

In the accompanying drawings forming a material part of this description, there is shown:

FIG. 1a illustrates a preferred embodiment of the present invention showing a micron conductive fiber heating element.

FIGS. 1b and 1c illustrates a preferred embodiment of the present invention showing a micron conductive fiber bundle and an individual strand.

FIGS. 2a and 2b illustrate a preferred embodiment of the present invention showing a micron conductive fiber heating element in top and side view.

FIGS. 3a, 3b, 3c, 3d, and 3e illustrate a preferred embodiment of the present invention showing a method to form a micron conductive fiber heating element.

FIGS. 4a, 4b, 4c, 4d, and 4e illustrate a preferred embodiment of the present invention showing a method to form a micron conductive fiber heating element.

FIGS. 5a, 5b, and 5c illustrate a preferred embodiment of the present invention showing a tubular micron conductive fiber heating element.

FIG. 6 illustrates a preferred embodiment of the present invention showing a heating system using a micron conductive fiber heating element.

FIGS. 7a and 7b illustrate a preferred embodiment of the present invention showing an electric heated pan using a micron conductive fiber heating element.

FIGS. 8a and 8b illustrate a preferred embodiment of the present invention showing an electric heated wok using a micron conductive fiber heating element.

FIGS. 9a and 9b illustrate a preferred embodiment of the present invention showing an electric heated skillet using a micron conductive fiber heating element.

FIGS. 10a and 10b illustrate a preferred embodiment of the present invention showing a portable electric heater using a micron conductive fiber heating element.

FIG. 11 illustrates a preferred embodiment of the present invention showing a grid electric heating element using micron conductive fiber.

FIG. 12 illustrates a preferred embodiment of the present invention showing a heating element formed by braiding micron conductive fiber.

### DESCRIPTION OF THE PREFERRED EMBODIMENTS

This invention relates to micron conductive fiber heating elements, methods of manufacture, and applications.

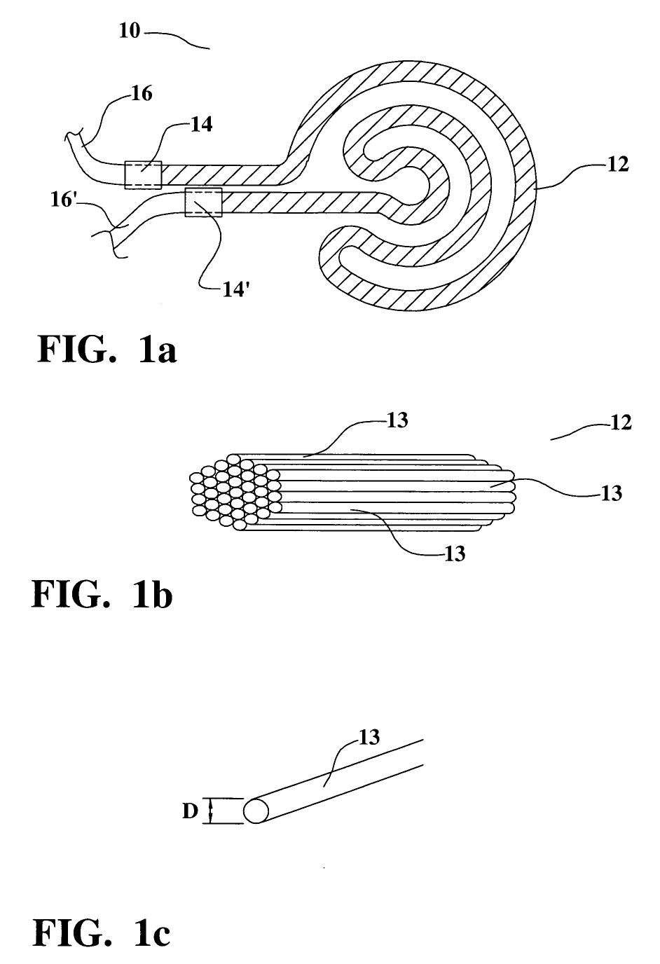

Referring now to FIG. 1a, a preferred embodiment 10 of the present invention is illustrated. A novel, micron conductive fiber heater 10 is shown. The micron conductive fiber heater 10 comprises a circuit of micron conductive fiber 12 through which electrical current is conducted and, in the process, is converted into heat. The micron conductive fiber circuit 12 forms the heating element for whatever device it is placed into. In this example, the micron conductive fiber circuit 12 is formed into a loop or coil to thereby concentrate heat transfer between the element 12 and the surrounding area. The micron conductive fiber 12 is coupled to an electrical source, such as a battery, a power transformer, or a wall alternating current source. In the exemplary embodiment, power cables or wires 16 and 16′ from the power source are coupled to the micron conductive fiber heating element 12 via couplings 14 and 14′. Features of the couplings will be further described below.

Referring now to FIGS. 1b and 1c, a micron conductive fiber bundle 12 and an individual micron fiber strand 13, respectively, are shown. The bundle 12 comprises a plurality of micron conductive fiber strands 13. The micron conductive fiber 13 may be metal fiber or metal plated fiber. Further, the metal plated fiber 13 may be formed by plating metal onto a metal fiber or by plating metal onto a non-metal fiber.

As important features of the present invention, the micron conductive fiber 13 comprises multiple strands of very fine fibers. In one embodiment, each fiber has a diameter of typically not greater than about 20 microns. In another embodiment, each fiber has a diameter of less than about 12 microns. The fibers comprise a metal, layers of metals, or metal alloys. Alternatively, the fibers comprise a non-metallic material having a metal or metal alloy plating such that a micron conductive fiber is achieved. Multiple strands of the micron conductive fiber are combined to form the bundle 12 as shown in FIG. 1b. In one embodiment, the bundle comprises between about 1 strand and about 20,000 strands of fiber. The fibers 13 may be twisted or non-twisted in the bundle 12. A wide range of bundle sizes, and respective wire gauges, can be formed from the micron conductive fiber depending on the diameter of the strands and the number of strands in each bundle.

The micron conductive fiber 13 in the bundle 12 provides excellent electrical conductivity and heat transfer. The surface area of each micron fiber 13 is useful for conduction. The summation of the fibers 13 in the bundle 12 creates a larger surface area for electrical and heat conduction than a comparative solid bulk of the same material.

As important features of the present invention, exemplary metal fibers 13 include, but are not limited to, stainless steel fiber, copper fiber, nickel fiber, silver fiber, aluminum fiber, or the like, or combinations thereof. Exemplary metal plating materials that are applied metal or non-metal fiber cores include, but are not limited to, copper, nickel, cobalt, silver, gold, palladium, platinum, ruthenium, and rhodium, and alloys of thereof. Nickel chromium (nichrome) alloys may be used. Any platable fiber may be used as the core for a non-metal fiber. Exemplary non-metal fiber cores include, but are not limited to, carbon, graphite, polyester, basalt, glass, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fiber cores in the present invention.

A ferromagnetic, micron conductive fiber element 12 may be formed according to the present invention to create a magnetic or magnetizable form of the material. Ferromagnetic materials, such as ferrite materials and/or rare earth magnetic materials are used for the micron conductive fiber bundle 12. The ferromagnetic, micron conductive fiber bundle 12 displays the excellent physical properties of the base resin, including flexibility, moldability, strength, and resistance to environmental corrosion, along with excellent magnetic ability. In addition, the unique ferromagnetic, micron conductive fiber element 12 facilitates formation of items that exhibit excellent thermal and electrical conductivity as well as magnetism. The ferromagnetic, micron conductive fiber element 12 may be magnetized by exposing the bundle 12 to a strong magnetic field.

A ferromagnetic micron conductive fiber bundle 12 may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. A ferromagnetic micron conductive fiber bundle 12 may further be a combination of a non-ferromagnetic micron conductive fiber and a ferromagnetic micron conductive fiber to form a micron conductive fiber bundle that combines excellent conductive qualities with magnetic capabilities.

The micron conductive fiber heater element 12 of the present invention combines excellent conductivity with low relative weight. A high strength and low weight bundle 12 can be formed using, for example, a metal-plated glass micron fiber. While a round cross-sectional shape is shown, any shape of strand 13 can be produced. While the illustration shows only a relatively few number of fiber strands 13 in the bundle 12, the overall bundle 12 actually comprises many individual fiber strands routed together. Thousands or tens of thousands of fibers are thus routed to form the bundle.

The micron conductive fiber strands 13 comprise a metal material in any form of, but not limited to, pure metal, combinations of metals, metal alloys, metals clad onto other metals, metals plated onto metal or non-metal cores, and the like. There are numerous metal materials that can be used to form the micron conductive fiber strands 13 according to the present invention. An exemplary list of micron conductive fiber materials includes, but is not limited to:
(1) copper, alloys of copper such as coppered alloyed with any combination of beryllium, cobalt, zinc, lead, silicon, cadmium, nickel, iron, tin, chromium, phosphorous, and/or zirconium, and copper clad in another metal such as nickel;
(2) aluminum and alloys of aluminum such as aluminum alloyed with any combination of copper, magnesium, manganese, silicon, and/or chromium;
(3) nickel and alloys of nickel including nickel alloyed with any combination of aluminum, titanium, iron, manganese, and/or copper;
(4) precious metals and alloys of precious metals including gold, palladium, platinum, platinum, iridium, rhodium, and/or silver;
(5) glass ceiling alloys such as alloys of iron and nickel, iron and nickel alloy cores with copper cladding, and alloys of nickel, cobalt, and iron;
(6) refractory metals and alloys of refractory metals such as molybdenum, tantalum, titanium, and/or tungsten;
(7) resistive alloys comprising any combination of copper, manganese, nickel, iron, chromium, aluminum, and/or iron;
(8) specialized alloys comprising any of combination of nickel, iron, chromium, titanium, silicon, copper clad steel, zinc, and/or zirconium;
(9) spring wire formulations comprising alloys of any combination of cobalt, chromium, nickel, molybdenum, iron, niobium, tantalum, titanium, and/or manganese;
(10) stainless steel comprising alloys of iron and any combination of nickel, chromium, manganese, and/or silicon;
(11) thermocouple wire formulations comprising alloys of any combination of nickel, aluminum, manganese, chromium, copper, and/or iron.

The micron conductive fiber strands 13 may be subjected to inert chemical modification processes, or surface treatments, that improve the fibers interfacial properties. Treatments include, but are not limited to, chemically inert coupling agents, gas plasma, anodizing, mercerization, peroxide treatment, benzoylation, and other chemical or polymer treatments. A chemically inert coupling agent is a material that is bonded onto the surface of metal fiber to provide an excellent coupling surface for later bonding with another material. An exemplary chemically inert coupling agent is silane. In a silane treatment, silicon-based molecules from the silane molecularly bond to the surface of metal fibers to form a silicon layer. The silicon layer bonds well, for example, with resin-based material yet is chemically inert with respect to resin-based materials. As an optional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion and/or reducing and preventing oxide growth (when compared to non-treated fiber).

Referring again to FIG. 1a, the power cables or wires 16 from the power source are coupled to the micron conductive fiber heating element 12 via couplings 14 and 14′. The couplings, or terminals 14 and 14′, are designed to mechanically and electrically connect the power supplying wires 16 to the micron conductive fiber 12. In addition, the terminals are designed to have a relatively large contact area with the fiber bundle 12 such that the heating current is spread across a surface area and not concentrated at single points. In one embodiment, a solderless crimp connector is used. A solderless crimp-on connector pierces the micron conductive fiber to establish electrical contact. In yet another embodiment, the micron conductive fiber may be ultrasonically welded, or bonded, to a connector. In another embodiment, micron conductive fiber wiring that has been bonded to a connector may be encased in a heat shrink structure, as is known in the art, to provide electrical insulation and stress relief.

According to another embodiment, the micron conductive fiber 13 is made solderable. A solderable micron conductive fiber 13 comprises either a solderable metal fiber or a solderable metal plating onto the fiber. A soldered connection may be made between the micron conductive fiber element 13 and any circuit or connector by use of a melted solder connection via point, wave, or reflow soldering. In another embodiment, a solderable ink film is used to connect the micron conductive fiber bundle 12 to another conductive circuit or connector. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the micron conductive fiber element 12 at the location of the applied solderable ink. Many other types of solderable inks can be used to provide this solderable surface onto the micron conductive fiber element of the present invention. Another exemplary embodiment of a solderable ink is a mixture of one or more metal powder systems with a reactive organic medium. This type of ink material is converted to solderable pure metal during a low temperature cure without any organic binders or alloying elements.

The micron conductive fiber strands 13 may be routed in parallel, as shown in the embodiment of FIG. 1b. Alternatively, the fiber strands 13 may be twisted, wound, or weaved together. The micron conductive fiber strands 13 may be wound into string or yarn. This conductive string or yarn is more easily handled than parallel strands and may further be weaved into a fabric. In one embodiment, such a conductive fabric, formed of micron conductive fiber yarn or string, is then used as form a heating element. In yet another embodiment, the micron conductive fiber strands 13 may be separated, or frayed, from each other to spread out the direct heating area.

When the heating element 12 of the present invention is subjected to an electrical current, a very rapid heating occurs in the fiber strands. This heat energy is then transferred from the fiber bundle 12 to the other objects by radiation, conduction, convection, induction, or any combination of these effects.

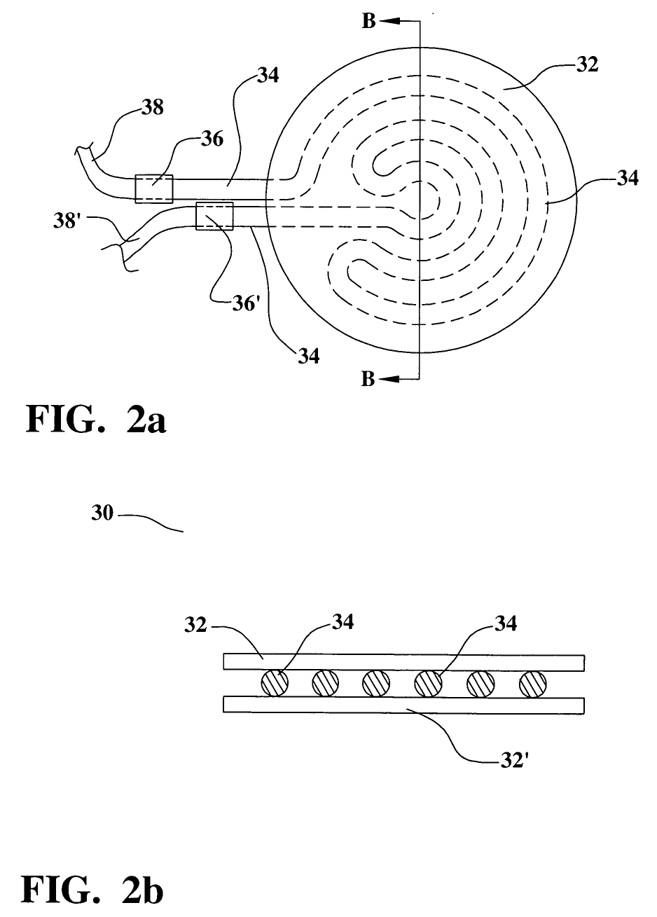

Referring now to FIGS. 2a and 2b, a preferred embodiment 30 of the present invention is illustrated. Another micron conductive fiber heater 30 is shown in top and side view. Again, a heating element 34 is formed as a loop of micron conductive fiber 34. This heating element 34 is coupled onto power terminals 38 and 38′ via couplings 36 and 36′. In most applications, it is necessary to provide an insulating layer 32 between the heating element 34 and anything that might come into contact with the heating element 34. For example, if a cooking pan were to be placed in direct contact with the micron conductive fiber heating element 34, then current flowing through the heating element 34 may be directed into the pan. To eliminate this possibility, an electrical insulating layer 32 is placed between the heating element 34 and any potential contact points. In the illustrated embodiment, electrical insulating layers 32 and 32′ are formed above and below the heating element 34. Alternatively, a single insulating layer may be used. The insulating layer 32 and 32′ should exhibit very low conductivity of electricity yet very good conductivity of the heat energy. In this way, the electrical insulating layer 32 also serves the function of a thermal spreading structure. Exemplary materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like.

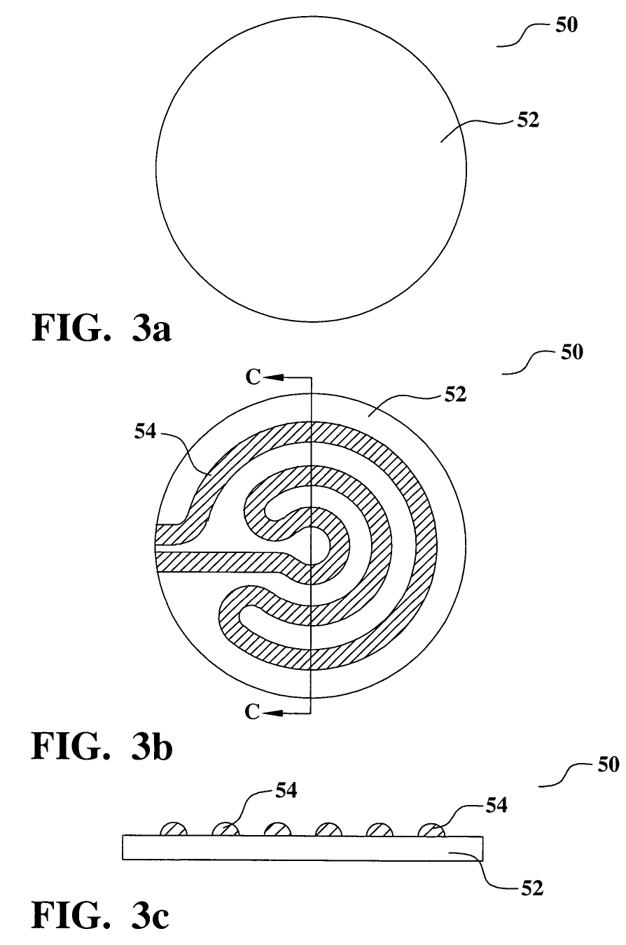

Referring now to FIGS. 3a-3e, a preferred embodiment of the present invention is illustrated. A heating element 50 is shown. In this embodiment, the connectors and power leads have been omitted to simplify the illustration. A method of forming a heating device is depicted in FIGS. 3a-3e. In FIG. 3a, a bottom plate 52 of the element 50 is shown. As described above, the bottom plate 52 comprises an electrical insulating layer to prevent current flow from leaking out of the micron conductive fiber. Referring now to FIG. 3b, an adhesive material 54 is placed onto the bottom plate 52. In one embodiment, a pressure sensitive adhesive (PSA) 54, is adhered to the bottom plate 52 in the desired coil pattern as shown in FIGS. 3b and 3c. The micron conductive fiber 56 is then placed onto the adhesive layer 54 and adheres into place as shown in FIG. 3d. In another embodiment, a two-sided adhesive tape 54, such as a Kapton™ or Mylar™ sheeting or tape with adhesive on each side is used.

In another embodiment, the micron conductive fiber 56 is first impregnated with a resin-based material. In various embodiments, the micron conductive fiber 56 is dipped, coated, sprayed, and/or extruded with resin-based material to cause the bundle of fibers to adhere together in a prepreg grouping that is easy to handle. This prepreg micron conductive fiber 56 is then placed, or laid up, onto the bottom insulating plate 52 in the coil arrangement and heated to form a permanent bond. In another embodiment, the prepreg micron conductive fiber 56 is placed into the bottom insulating plate 52 while the impregnating resin is still wet. The prepreg fiber 56 is then wet laid up on to the bottom plate 52 and cured by heating or other means. In one embodiment, wet prepreg is formed by spraying, dipping, or coating the micron conductive fiber 56 in high temperature capable paint. In any of these embodiments, the micron conductive fiber 56 may be twisted, wound, or woven in a yarn, string, or fabric prior to impregnation with a resin-based material.

Following placement of the micron conductive fiber 56 into the bottom plate 52, the top plate 58 is placed as is shown in FIG. 3e. As described above, the top plate 58 should comprise a material that exhibits very low conductivity of electricity and very good conductivity of the heat energy. In this way, the top plate 58 forms a thermal spreading structure for the heating device. Exemplary materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like.

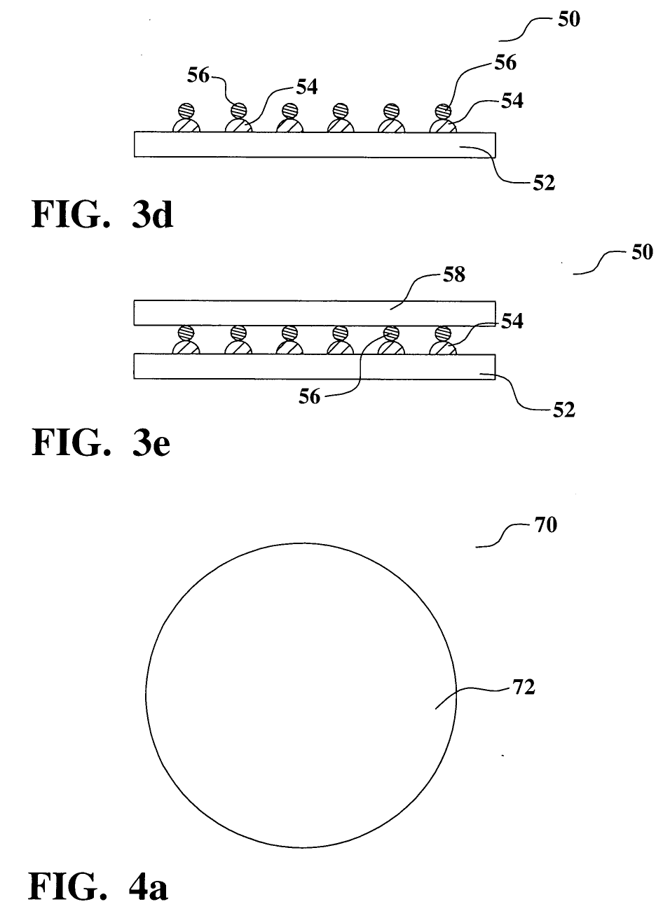

Referring now to FIGS. 4a-4e, a preferred embodiment of the present invention is illustrated. Another method to form a heating element 70 is shown. In this case, channels 74 are formed into the bottom plate 72 in the desired shape of the heating coil 76. In one embodiment, the bottom plate 72 begins as a blank having a flat surface as shown in FIG. 4a. A coil channel 74 is then formed into the bottom plate 72 by routing, pressing, or the like as shown in FIGS. 4b and 4c. For example, aluminum may be used for the bottom plate 72. After forming the channels 74, an insulating coating of high temperature capable paint of anodizing is formed over the aluminum. The micron conductive fiber 76 is then placed into the routing channels as shown in FIG. 4d. The top plate 78 is then placed as shown in FIG. 4e. In another embodiment, the bottom plate 72 is pre-formed with the channels 74. For example, if a high temperature capable resin-based material is used, then the bottom plate may be molded into the shape shown in FIGS. 4b and 4c.

The heating elements of FIGS. 3a-3e and 4a-4e may comprise top plates or bottom plates, or both plates, comprising conductive loaded resin-based materials such as described in U.S. Pat. No. 7,027,304 to Aisenbrey that is incorporated herein by reference. Conductive loaded resin-based materials, or conductively doped resin-based materials provide excellent thermal conductivity through the substantial homogenization of micron conductive materials, such as fiber and powder, in a resin-based material. Referring particularly to FIG. 3e, the heat spreading plates 52 and 58 may be easily molded of conductive loaded resin-based material and the micron conductive fiber 56 then adhered into place. Referring particularly to FIG. 4e, the heat spreading plates 72 and 76 may be molded of the conductive loaded resin-based material and then the micron conductive fiber 76 routed in the channels of the molded plates. Alternatively, the conductive loaded resin-based material plates 72 and 78 may be molded around the micron conductive fiber 76 via insertion molding. As another embodiment, an electrically insulating coating may be applied to the conductive loaded resin-based material 72 and 76 to electrically isolated the micron conductive fiber 76 from the conductive loaded resin-based material 72 and 76. Alternatively, an electrically insulating coating may be applied over conductive loaded resin-based material 72 and 76 to electrically isolated the completed element 70.

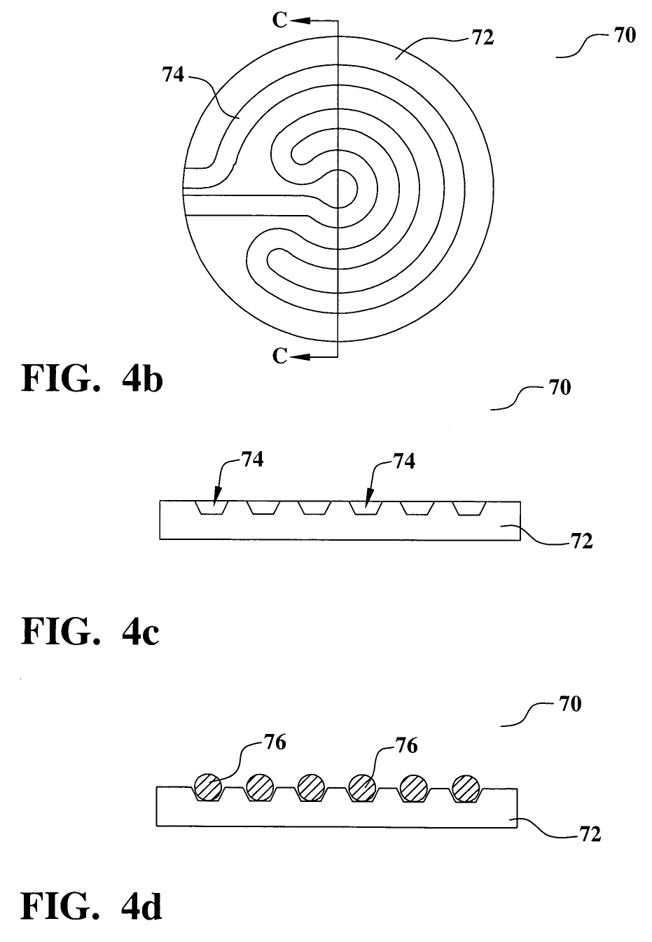

Referring now to FIGS. 5a-5c, a preferred embodiment of the present invention is illustrated. A method for forming a tubular heating device 100 is shown. The tubular heating device 100 comprises an external tubing 102, which preferably is electrically non-conductive but thermally conductive, with an internal heating element comprising the micron conductive fiber 104. Exemplary external tubing 102 materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like. In one embodiment, the micron conductive fiber 104 is first pulled through external tubing 102 as shown in FIG. 5b. Then, the combined tubing 102 and element 104 are shaped into a heating coil as shown FIG. 5c. For example, the combined tubing 102 and element 104 are heated until the outer tubing 104 becomes flexible and then wound into the coil shape 102′. In another embodiment, the outer tubing is first formed into the final shape 102′. The micron conductive fiber 104 is then pulled through the tubing.

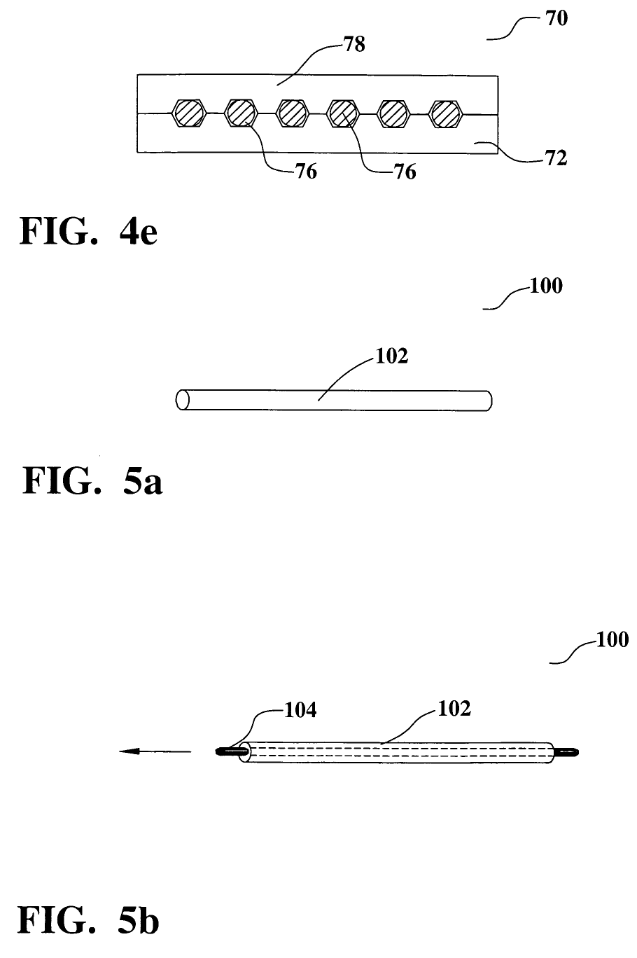

Referring now to FIG. 6, a preferred embodiment of the present invention is illustrated. A control system 130 for a heater based on the micron conductive fiber is shown. A heating device 132 is formed with a micron conductive fiber heating element. A battery 136 is used for electrical power. In alternative embodiments, an AC to DC converter is used to provide power or the heater is powered directly from an AC source. A controller 134 is used to control the amount of power delivered to the element 132. A temperature probe 138 is attached to the heating element 132. The controller 134 uses the temperature probe 138 to regulate the amount electrical power.

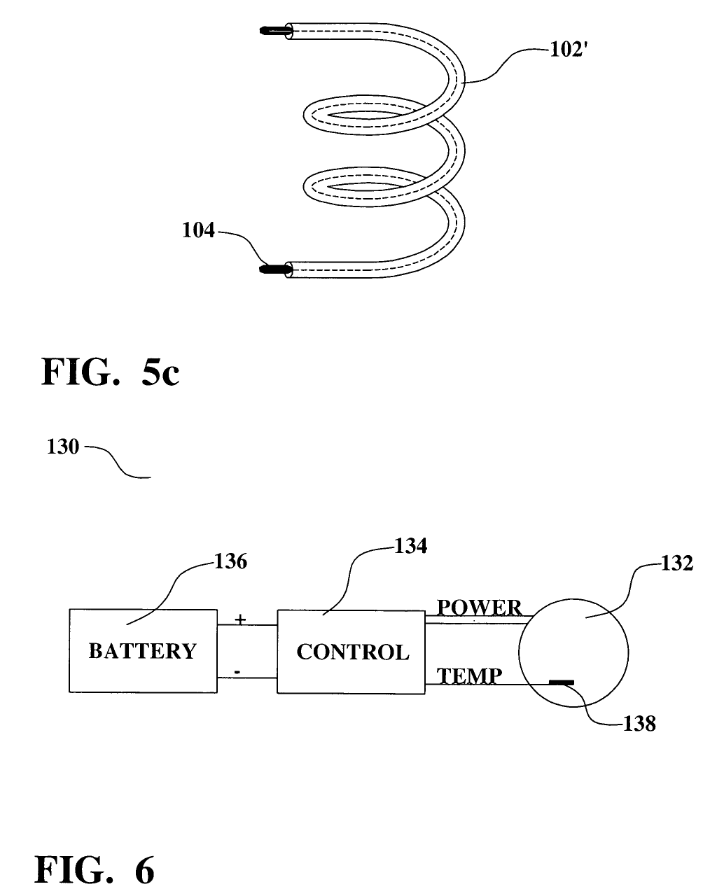

Referring now to FIGS. 7a-7b, a preferred embodiment of the present invention is illustrated. An electric cooking pan 200 is shown. The pan 200 comprises bottom 208 and side sections 204 and a handle 220. The micron conductive fiber is routed through the bottom 208 and/or side sections 204 to form a continuous circuit. In the exemplary embodiment, a coil 216 is formed in the bottom section 208 while a wave pattern 212 is formed on the sides. As an additional feature, a controller 224 is formed into the handle 220. The controller may contain a battery source, an AC-to-DC converter, or simply an AC connection. The controller regulates the electrical power flowing to the micron conductive fiber element 212 and 216. Any of the above described techniques and materials may be used for manufacturing the electric pan device 200. A wide variety of pan types, including skillets, boilers, sauce pans, pots, and the like may be formed in this way.

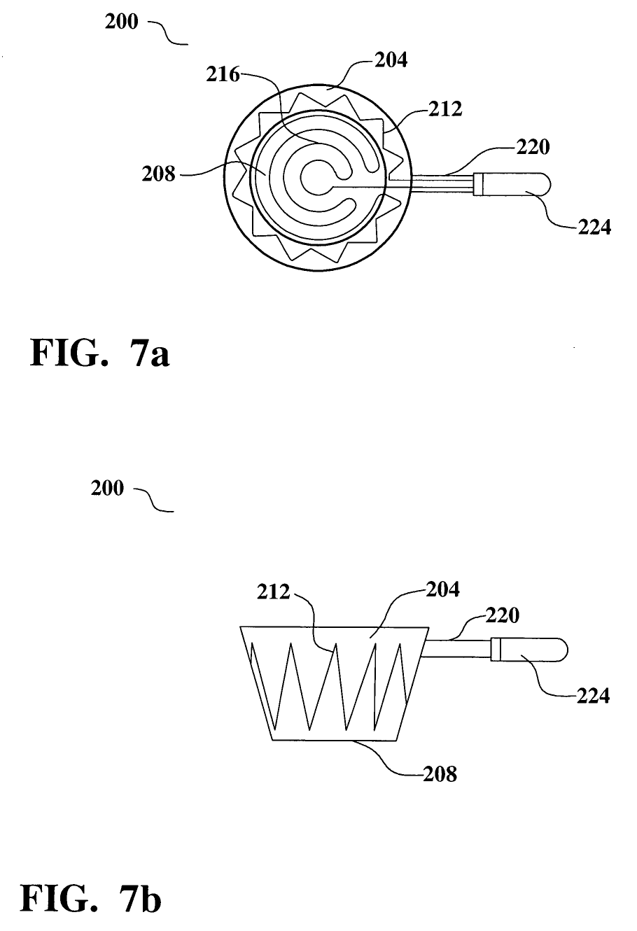

Referring now to FIGS. 8a and 8b, a preferred embodiment of the present invention shows an electric heated wok using a micron conductive fiber heating element. The pan 300 comprises bottom 308 and side sections 304 and a handle 320. The micron conductive fiber is routed through the bottom 308 and/or side sections 304 to form a continuous circuit. In the exemplary embodiment, a coil 312 is formed in the bottom section 308. As an additional feature, a controller 324 is formed into the handle 320. The controller may contain a battery source, an AC-to-DC converter, or simply an AC connection. The controller regulates the electrical power flowing to the micron conductive fiber element 312. Any of the above described techniques and materials may be used for manufacturing the electric wok device 300.

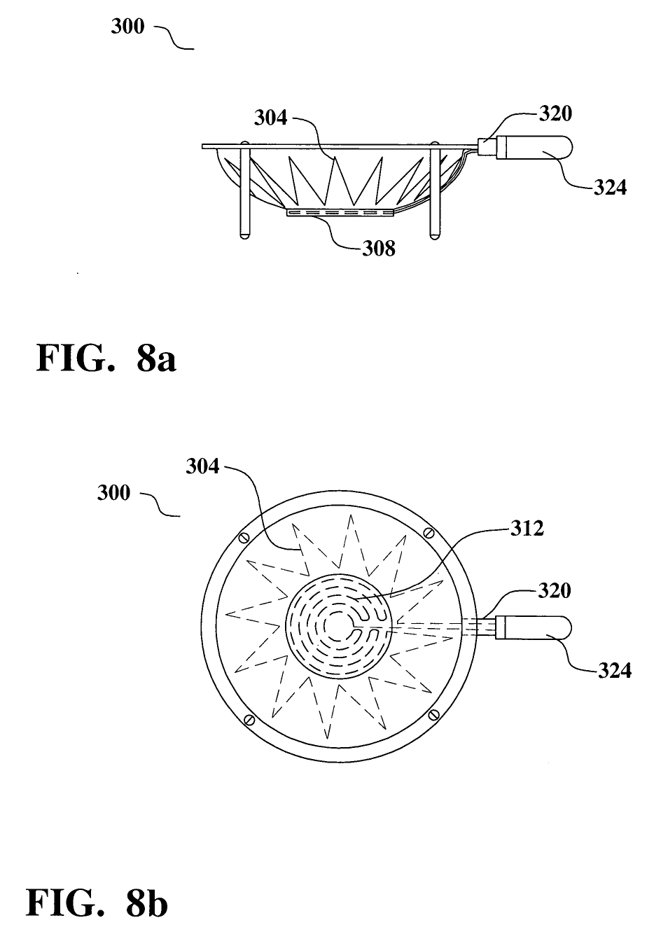

Referring now to FIGS. 9a and 9b a preferred embodiment of the present invention shows an electric heated skillet using a micron conductive fiber heating element. The pan 350 comprises bottom 358 and side sections 354 and a handle 370. The micron conductive fiber is routed through the bottom 358 and/or side sections 354 to form a continuous circuit. In the exemplary embodiment, a coil 362 is formed in the bottom section 358. As an additional feature, a controller 374 is formed into the handle 370. The controller may contain a battery source, an AC-to-DC converter, or simply an AC connection. The controller regulates the electrical power flowing to the micron conductive fiber element 362. Any of the above described techniques and materials may be used for manufacturing the electric skillet device 350.

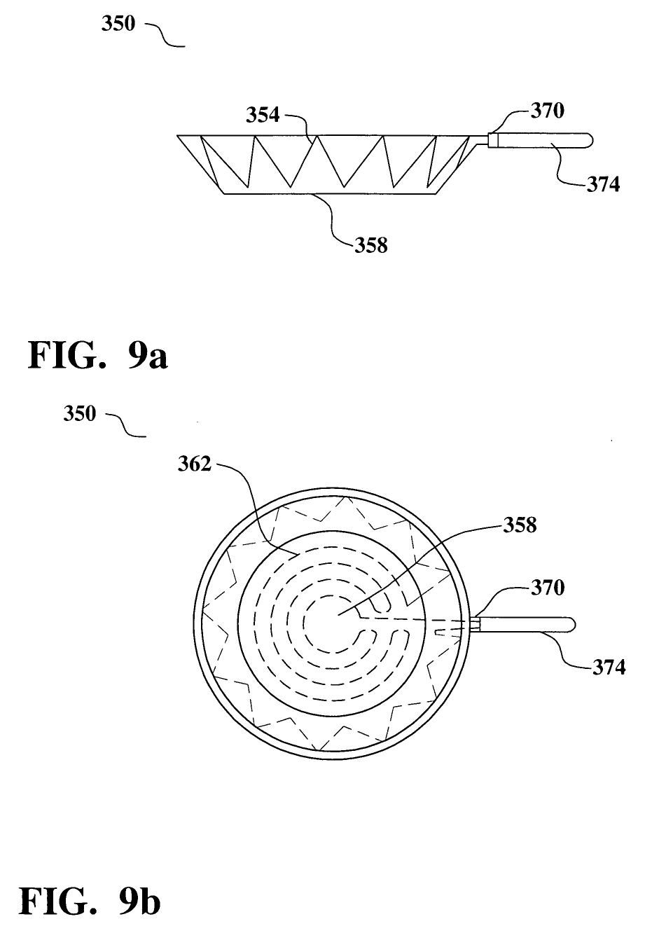

Referring now to FIGS. 10a and 10b, a preferred embodiment of the present invention shows a portable electric heater 400 using a heating element 408 comprising a bundle of micron conductive fiber. A rotating fan 404 is used to blow air through the heating element 408. A power source 412 is used to provide electrical power to the fan 404 and heating element 408. For example, a battery may used in the source 412 to create a portable heating device 400. The heating element 408 comprises micron conductive fiber in a bundle. The fiber bundle 408 may be further coated or surrounded with an electrically non-conductive but thermally conductive material. Exemplary external materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like.

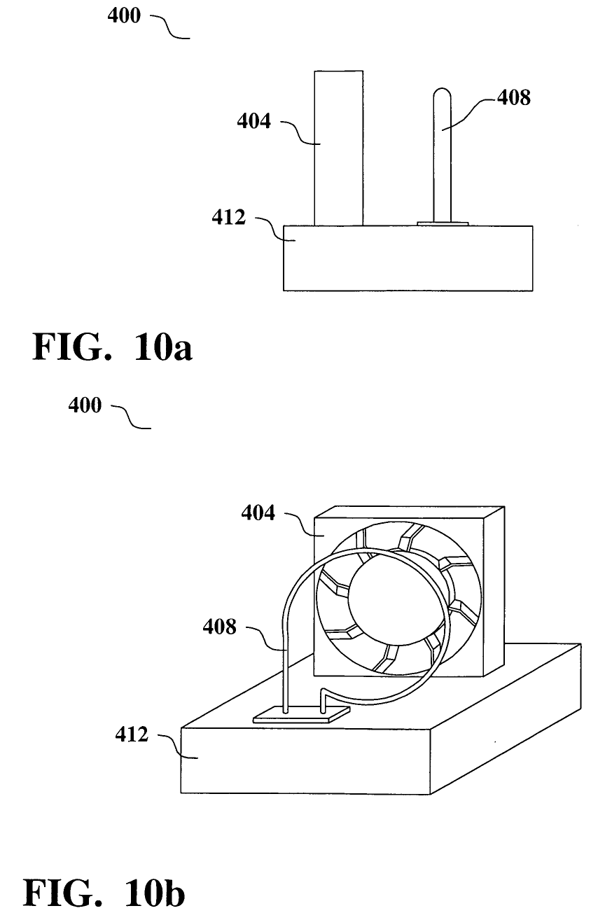

FIG. 11 illustrates a preferred embodiment of the present invention showing a grid electric heating element 504 comprising a bundle of micron conductive fiber. A power source, not shown, is used to provide electrical power to the heating element 504. An insulating spacer 508 may be used to provide physical separation of adjacent sections of the bundle 504. The heating element 504 comprises micron conductive fiber in a bundle. The fiber bundle 504 may be further coated or surrounded with an electrically non-conductive but thermally conductive material. Exemplary external materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like.

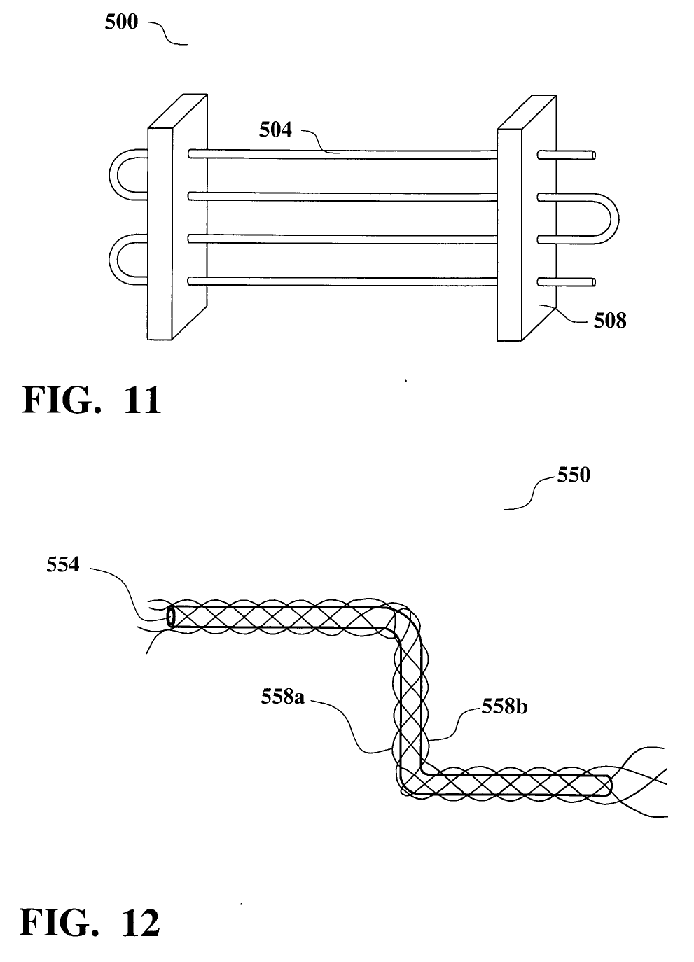

Referring to FIG. 12, a preferred embodiment 550 of the present invention shows a heating element 558a and 558b formed by braiding micron conductive fiber. A power source, not shown, is used to provide electrical power to the heating element 558a and 558b. Sub-bundles 558a and 558b of micron conductive fiber are wound, braided, or otherwise routed around an article, in this case a pipe 504. For example, the sub-bundles 558a and 558b are braided onto a pipe used for heating blood. The braided sub-bundles 558a and 558b generate an excellent three-dimensional heating of the piping. The fiber bundle 504 may be further coated or surrounded with an electrically non-conductive but thermally conductive material. Exemplary external materials include glass and glass-based materials, such as Pyrex™; quartz; high temperature capable resin-based materials; ceramics and ceramic-based materials, such as Pyroceram™ and Neoceram™; mica and mica-based materials; or metals coated with insulating layers, such as high temperature paints, anodizing, and the like.

The above detailed description of the invention and the examples described therein have been presented for the purposes of illustration and description. While the principles of the invention have been described above in connection with a specific device, it is to be clearly understood that this description is made only by way of example and not as a limitation on the scope of the invention.

What is claimed is:

1. A heating element device comprising a bundle of micron conductive fiber wherein each micron conductive fiber has a diameter of not greater than 20 microns and wherein the bundle is operative to conduct electrical current from a first end to a second end of the bundle.

2. The device of claim 1 further comprising an electrical insulating layer surrounding the bundle.

3. The device of claim 2 wherein the electrical insulating layer is glass or quartz.

4. The device of claim 2 wherein the electrical insulating layer is ceramic-based or mica-based.

5. The device of claim 2 wherein the electrical insulating layer is a high temperature capable resin or paint.

6. The device of claim 1 wherein the diameter of the micron conductive fiber not greater than about 12 microns.

7. The device of claim 1 wherein the micron conductive fiber is metal.

8. The device of claim 1 wherein the micron conductive fiber is a non-metal material with metal plating.

9. The device of claim 1 wherein the micron conductive fiber is a ferromagnetic material.

10. The device of claim 1 wherein the micron conductive fiber is surface treated.

11. The device of claim 1 wherein the first and second ends of the bundle are coupled to an electrical current source by connectors.

12. The device of claim 1 wherein the bundle is held near a thermal spreading structure.

13. The device of claim 1 wherein the bundle is held inside of a thermal spreading structure.

14. The device of claim 1 wherein the micron conductive fibers are woven, weaved, or twisted together.

15. A heating element device comprising:
a bundle of micron conductive fiber wherein each micron conductive fiber has a diameter of not greater than 20 microns and wherein the bundle is operative to conduct electrical current from a first end to a second end of the bundle; and
an insulating layer surrounding the bundle.

16. The device of claim 15 wherein the electrical insulating layer is glass or quartz.

17. The device of claim 15 wherein the electrical insulating layer is ceramic-based or mica-based.

18. The device of claim 15 wherein the electrical insulating layer is a high temperature capable resin or paint.

19. The device of claim 15 wherein the diameter of the micron conductive fiber not greater than about 12 microns.

20. The device of claim 15 wherein the micron conductive fiber is metal.

21. The device of claim 15 wherein the micron conductive fiber is a non-metal material with metal plating.

22. The device of claim 15 wherein the micron conductive fiber is a ferromagnetic material.

23. A heating element device comprising:
a bundle of micron conductive fiber wherein each micron conductive fiber has a diameter of not greater than 20 microns and wherein the bundle is operative to conduct electrical current from a first end to a second end of the bundle; and
a thermal spreading structure held near the bundle.

24. The device of claim 23 further comprising an electrical insulating layer between the thermal spreading structure and the bundle.

25. The device of claim 23 wherein the thermal spreading structure is conductive loaded resin-based material comprising micron conductive materials in a base resin host.

26. The device of claim 23 wherein the diameter of the micron conductive fiber not greater than about 12 microns.

27. The device of claim 23 wherein the thermal spreading structure is a tube.

28. The device of claim 23 wherein the thermal spreading structure is a plate.

29. The device of claim 23 wherein the bundle is held in a channel in the thermal spreading structure.

30. The device of claim 23 wherein the bundle is held together by adhesive or paint.
